(19) United States
(12) Patent Application Publication
(10) Pub. No.: US 2001/0049565 A1
(43) Pub. Date: Dec. 6, 2001

(54) System and method for contraband retrieval in drainage/sewer systems

(76) Inventor: John R. Otterman, Akron, OH (US)

Correspondence Address: OLDHAM & OLDHAM CO, TWIN OAKS ESTATE, 1225 W MARKET STREET, AKRON, OH, 44313, US

(21) Appl. No.: 09/826,305

(22) Filed: Apr. 4, 2001

Related U.S. Application Data
(60) Provisional application No. 60/195,493, filed on Apr. 6, 2000.
(60) Provisional application No. 60/199,729, filed on Apr. 24, 2000.

(51) Int. Cl. G01M 19/00; G05B 15/00; G06F 15/00

(52) U.S. Cl. 700/83; 73/865.8; 702/188

(57) ABSTRACT

The system and method of the present invention uses a combination of conventional video inspection equipment designed for evaluating the condition of sewer pipes, along with specially developed or adapted tools. The system and method make it possible to locate and capture contraband or other substances that might be flushed into the sewer lines from a particular residence or location while video recording the entire sequence of events. The system and method is also capable of dislodging and recovering contraband that may be stuck in the drains or lateral sewer lines. The system and method can also recover dissolved contraband from the effluent of a sewer lateral or drain. The present invention also provides a method for the use of the system with law enforcement to coordinate activities, record and recover contraband that has been flushed down a drain, and to associate a particular lateral sewer with a particular residence or building.

This application claims the benefit of U.S. Provisional Application No. 60/195,493 filed Apr. 6, 2000, and U.S. Provisional Application No. 60/199,729 filed Apr. 24, 2000. Application Ser. Nos. 60/195,493 and 60/199,729 are hereby incorporated by reference.

### TECHNICAL FIELD

The present invention relates to a method and system for detecting and recovering items in building drainage systems and/or associated sewer systems. More particularly, the present invention relates to a method and system for monitoring the effluent discharged from sewer lines associated with a particular residence or building and retrieving any substances that may be discarded by the occupants in order to avoid detection by law enforcement officials.

### BACKGROUND OF THE INVENTION

Law enforcement officers raiding a building where illegal drugs are suspected are often foiled by the building occupants who manage to get rid of any potential evidence by flushing the illegal drugs down the toilet prior to being apprehended. The occupants may be tipped off to the presence of law enforcement officers outside the building and are thus able to discard their drugs to avoid arrest and prosecution. The illegal drugs are swept away by the sewer system and the criminals are able to continue their illegal activities.

Presently there are no systems or methods for monitoring, recording and retrieving illegal drugs that have been flushed into the sewer system in a manner that they are associated with a particular building or residence.

There are currently prior art devices that have been developed to inspect sewage pipes by detecting and locating leaks in main sewer lines and building service lateral sewer pipelines. These devices typically use a remote control carrier with a miniature video camera mounted upon it to inspect main sewer lines. Electrical power and video signals for the miniature camera are transmitted through a cable connected to the camera, which is spooled out as the carrier travels through the sewer pipe. The lateral sewer lines and drainage pipes are typically inspected using a push reel system, which uses a flexible cable to push a miniature video camera, which may be mounted on a carrier. Although some versions are designed to fix problems associated with the pipe, these devices are generally limited to inspection of the pipes.

Therefore, there remains a need in the art for a system and method for monitoring, recording and retrieving contraband that has been flushed into the sewer system in a manner that they are associated with a particular building or residence and can be used as evidence of illegal activity.

### SUMMARY OF THE INVENTION

The system and method of the present invention uses a combination of conventional video inspection equipment designed for evaluating the condition of sewer pipes, along with specially developed or adapted tools. The system and method make it possible to locate and capture contraband or other substances that might be flushed into the sewer lines from a particular residence or location while video recording the entire sequence of events. In another alternate embodiment, the system can also recover dissolved contraband from the effluent of a sewer lateral or drain. These and other improvements are provided by a system for recovering contraband from a drainage/sewer system comprising a remotely controlled device movable within said drainage/sewer system having a camera mounted on the device and means for capturing the contraband.

In an alternate embodiment, the system is capable of dislodging and recovering contraband that may be stuck in the drains or lateral sewer lines. These and other improvements are provided by a system for recovering contraband from a building drain and associated sewer system comprising a remotely controlled device movable within said building drain and sewer system having a camera mounted on the device and means for pushing the contraband through the building drain and sewer system to a position where the contraband is recoverable.

The present invention also provides a method for the use of the system with law enforcement to coordinate activities, record and recover contraband that has been flushed down a drain, and to associate a particular lateral sewer with a particular residence or building. These and other improvements are provided by a method of recovering contraband from a sewer system comprising positioning a remotely controlled device having a camera mounted thereon into a first sewer line. Next, the method requires locating a sewer connection wherein a second sewer line connects to said first sewer line; said second sewer line servicing a predetermined building. Next, the method requires gathering evidence of said contraband originating from said second sewer line; and then recovering said contraband.

In an alternate embodiment, the method can be used to recover dissolved contraband from the effluent of a sewer lateral or drain. These and other improvements are provided by a method of recovering contraband from a sewer system comprising the steps of positioning a remotely controlled camera and a residue collector in a first sewer line, then locating a sewer connection wherein a second sewer line connects to the sewer line wherein said second sewer line services a predetermined building. The method then requires positioning the residue collector within the second sewer line such that at least a portion of any contraband dissolved within an effluent flowing through the second sewer line is captured by the residue collector, which is then retrieved from the second sewer line. Once retrieved, the residue collector is then tested for contraband.

### BRIEF DESCRIPTION OF THE DRAWINGS

Better understanding of the present invention will be had when reference is made to the accompanying drawings, wherein identical parts are identified with identical reference numerals, and wherein:

FIG. 1 is a perspective view of a conventional portable monitoring unit having a video monitor, a controller for the tracker, a spool out length indicator, and a video recording device;

FIG. 2 is a perspective view of a conventional power tracker platform typically attached to a cable from the portable monitoring unit of FIG. 1;

FIG. 3 is a perspective view of a conventional camera mounted in a camera housing and attachable to the power tracker of FIG. 2;

FIG. 4 is a perspective view of a conventional push reel device;

FIG. 5 is a perspective view of a conventional camera mounted to the end of a cable and showing the push squeegee of the present invention as used in conjunction with the push reel device of FIG. 4;

FIG. 6 is a perspective view of a residue collector in accordance of the present invention mounted behind the camera on the end of the cable of FIG. 5;

FIG. 7 is a top view of a catch screen in accordance with the present invention;

FIG. 8 is a general schematic view of a main sewer line and various components as described by the method of the present invention;

FIG. 9 is a flow chart depicting a method of the present invention; and

FIG. 10 is a flow chart depicting an alternate method of the present invention.

### DETAILED DESCRIPTION OF THE DRAWINGS

The system 10 of the present invention is used for the documentation, discovery, retrieval, and association of substances, such as contraband 80, from drains and sewer lines 34 belonging to a particular residence or building 76. Typical contraband 80 found at a raided location includes controlled substances, drugs, drug paraphernalia, weapons, guns, ammunition, etc. The contraband 80 may be in an insoluble form such as capsules, caplets, etc; it may also be in a soluble form such as powder, or briquettes dissolved and flushed down the drains; the powder may be in sealed or unsealed plastic bags, aluminum foil or the like.

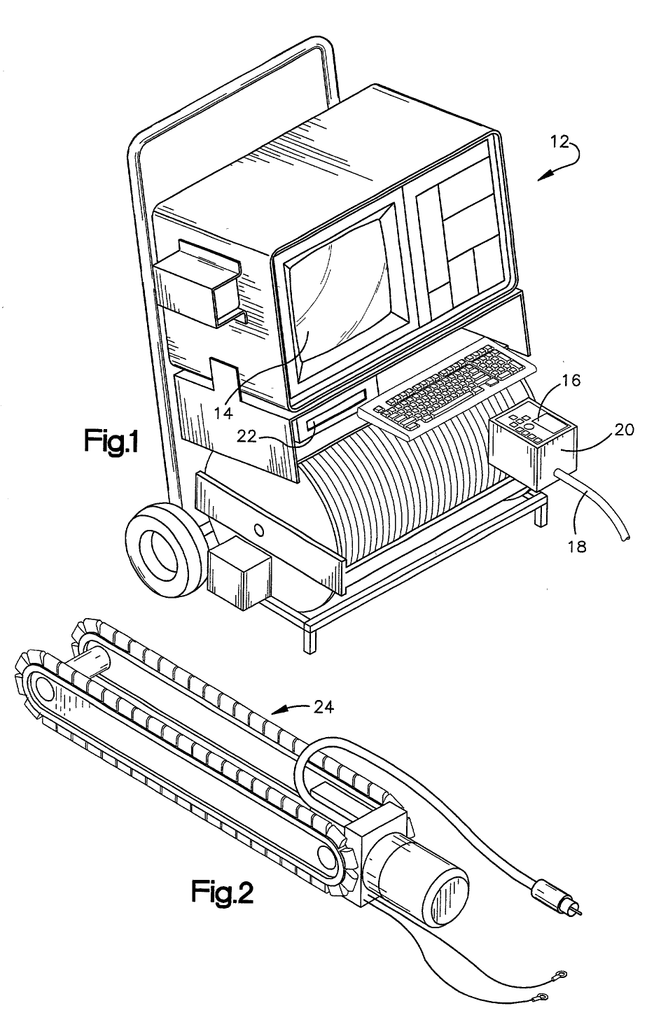

The system 10 typically comprises a portable television pipeline inspection monitoring unit 12 as shown in FIG. 1. The conventional monitoring unit 12 comprises a video monitor 14, a controller 16, a cable 18 with a spool out length indicator 20, and a video recording device 22. The cable 16 is attached to a conventional powered tracker device 24 shown in FIG. 2. A video camera 26 secured in a housing 28 mountable to the tracker device 24 is shown in FIG. 3.

The monitoring unit 12 enables a user to remotely control the tracker device 24 within the sewer pipe 30. The cable 18 is attached to the tracker device 24. The cable 18 provides power to the tracker device 24, the video camera 26 and associated lights 32. The cable 18 also serves as a conduit to control the movement of the tracker device 24 with the controller 16 and for video signals from the video camera 26. The video signals are shown on the video monitor 14 and recorded by the video recording device 22. The spool out length indicator 20 enables the user to monitor the exact distance that the tracker device 24 has traveled. The distance is superimposed on the video monitor 14 and recorded by the video recording device 22.

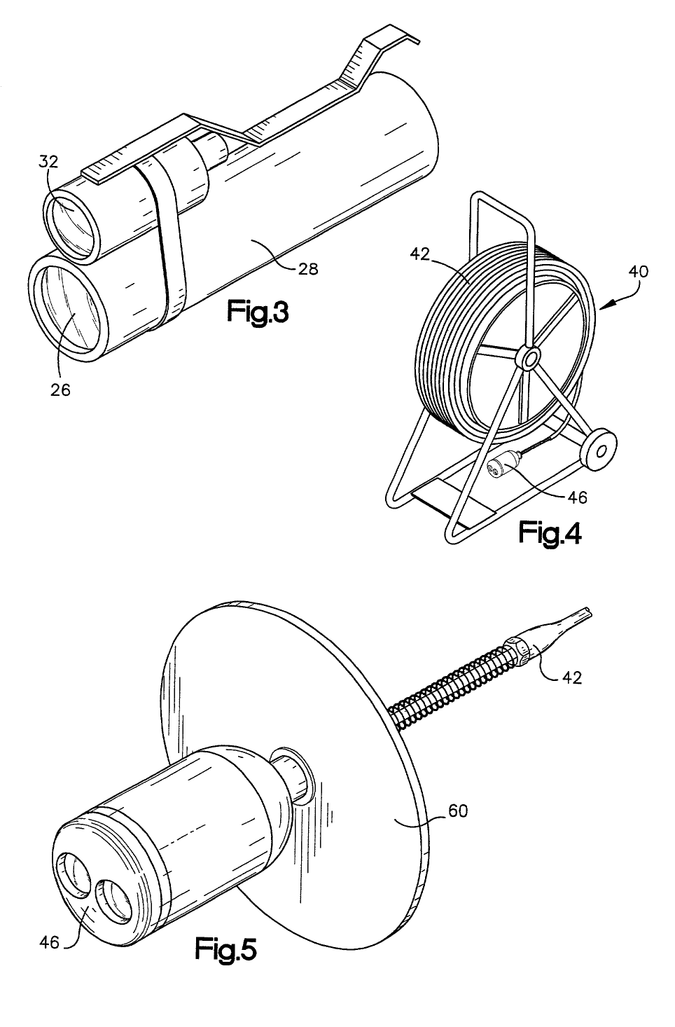

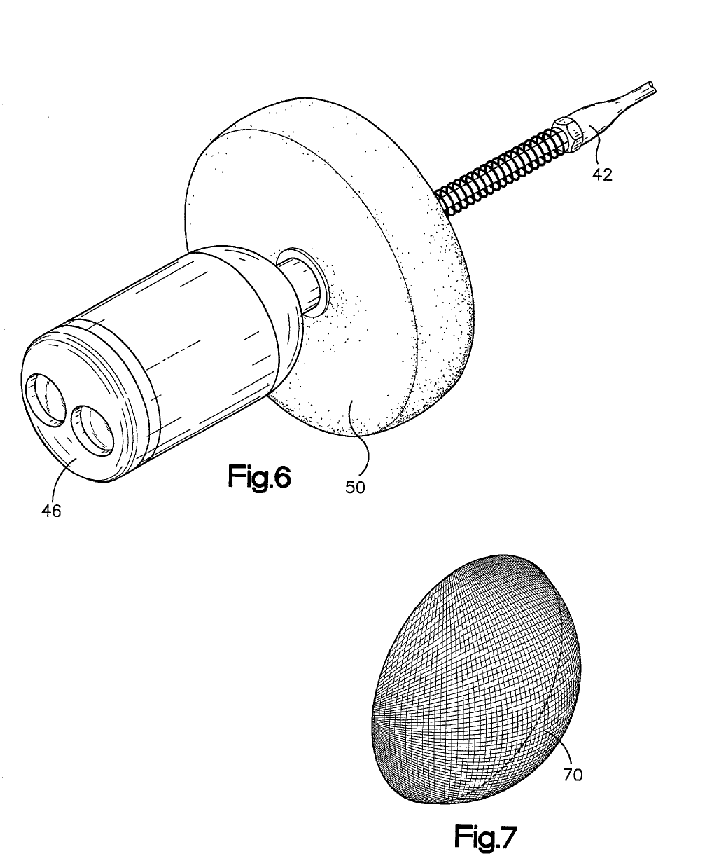

For inspection and retrieval of contraband 80 caught within interior drains and lateral sewer pipes 34, the system 10 uses a push reel unit 40 having a push cable 42 attached to a miniature camera 46, as shown in FIGS. 4 and 5. The system 10 further comprises a novel residue collector 50 and/or a novel push squeegee 60 mounted on the cable 42 directly behind the camera 46, as shown in FIG. 6, which will be described in detail below.

The system 10 also utilizes a novel catch screen 70, as shown in FIG. 7, to help capture any contraband 80 which may have been carried by the effluent through the main sewer line 30. The catch screen 70 comprises a screen adapted to block objects from entering a main sewer line 30. The screen size is such that it allows water to flow unrestricted while trapping and containing any undissolved items such as contraband 80 which may be flushed through the sewer system. The catch screen 70 enables the contraband 80 to be retained and held until retrieved by the system operators, thus allowing the contraband 80 to possibly be used as evidence. The catch screen 70 can be made in any size to accommodate various sizes of sewer pipes. Traditional sewer sizes are 8″, 10″, 12″, 15″, 18″, 21″, 24″, 27″, 30″, and 36″; however, the catch screen 70 could be custom fit and made to any size necessary

The push squeegee 60 is adapted and formed to push relatively large items through a drain pipe or lateral sewer pipe 34. The push squeegee 60 is typically made of, but not limited to, rubber, sponge, cotton or the like or combinations thereof or the like. The push squeegee 60 typically round to conform to the pipe interior and is generally located directly behind the miniature camera 46. The push squeegee 60 is generally used when a large amounts of contraband 80 substances have been flushed into the sewer lines, but have not totally dissolved or have become lodged in the drain or in the lateral sewer line 34. The lodged item may also be a knife or a gun. The user of the push reel unit 40 forces the cable 42 through the drain pipes and lateral sewer line 34 toward the main sewer line 30. The camera 46 mounted on the cable 42 enables the user to locate and record the discovery of the contraband 80. The push squeegee 60 is then used to push the contraband 80 through the pipes and lateral sewer line 34 toward the main sewer line 30. The items are then recovered using other system 10 elements as later described in the method of the present invention.

The residue collector 50 is adapted and formed to absorb residue from the fluid within the drains or lateral sewer pipe 34. It is possible that any contraband 80 may have been dumped into the toilet or drain where it completely dissolved into the water. The residue collector 50 is adapted to be attached to the end of the push cable 42 generally behind the miniature camera 46. If contraband 80, such as drugs, are dissolved into the water and flushed through the drains and lateral pipe 34, a significant and detectable residue will remain in the pipes 34. When the water drains through the pipe 34, such as when flushing the toilet, the residue collector 50 becomes at least partially submerged and is able to absorb any dissolved contraband 80 that may not be easily visible, but yet is still present in the pipes 34 after being flushed. After the residue collector 50 has been reeled through the drain pipes/sewer lateral 34, it can be pulled back and secured until it can be tested for illegal substances and potentially used as evidence. The residue collector 50 can be any suitable size or shape and comprised of any suitable material which will absorb residue from a liquid medium.

In an alternate embodiment, the push squeegee 60 and the residue collector 50 are combined as one element by either adding an absorbent material to the squeegee or by using a squeegee made of an absorbent material. The squeegee/residue collector combination must be rigid enough to push contraband 80 through the drain and/or sewer pipes.

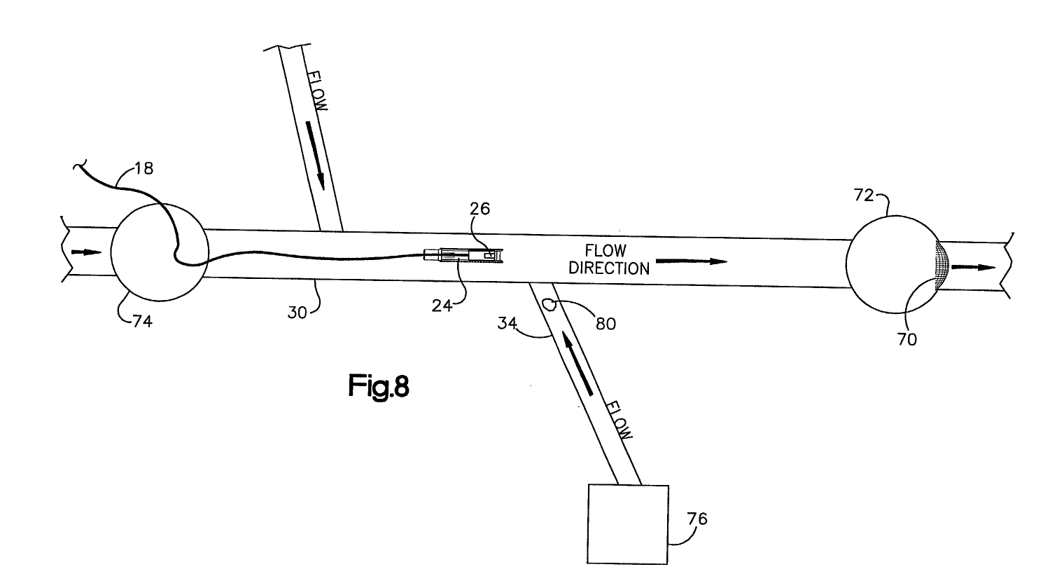

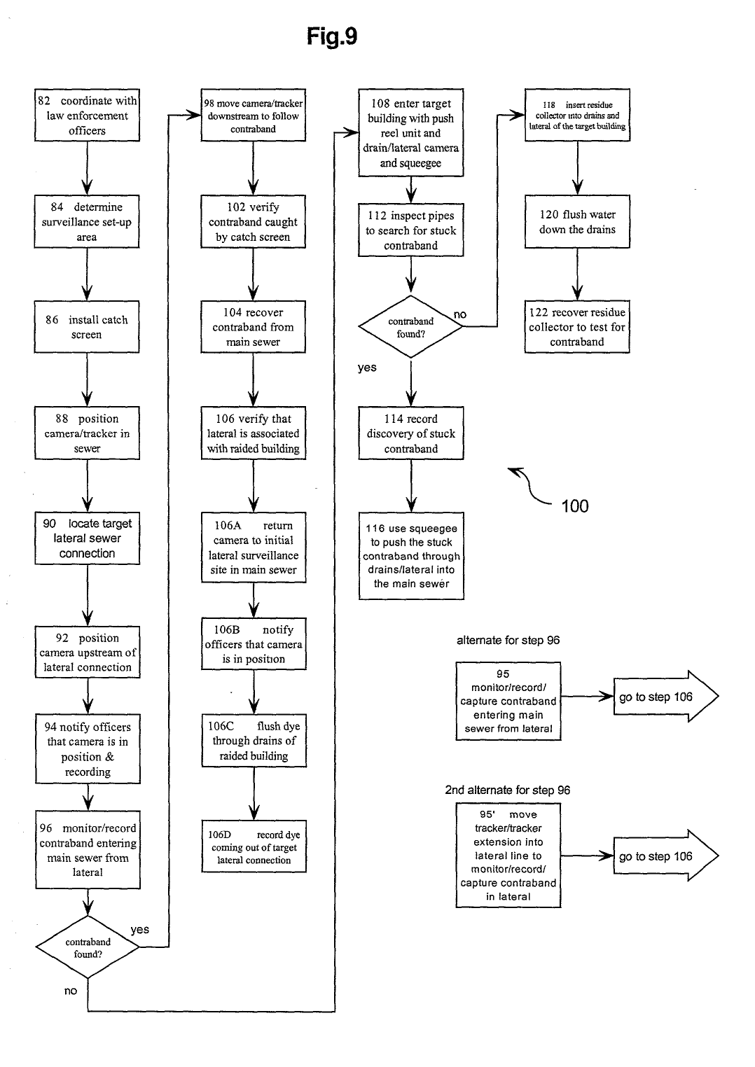

The method 100 of the present invention, as represented in FIG. 9, comprises the following steps typically performed in cooperation with local law enforcement officers 82. Prior to the arrival of the law enforcement raid team, the sewer camera team determines and selects the proper sewage surveillance area 84. This location is typically the first upstream manhole 74 from the lateral sewer 34 connection of the building 76 or location which will be the subject of the raid by law enforcement officers. The correct lateral sewer location 34 can be determined by using underground sewer records, the distance of the property from the first manhole, or by other means in the days prior to the raid, if necessary. It is possible that the crew is positioned further away from the residence or building, generally 800 to 900 feet, if necessary to avoid causing any suspicion. The typical setup is shown in FIG. 8.

In the next step, the catch screen 70 of an appropriate size is installed 86 in the first downstream manhole 72 from the suspect residence/location 76. The catch screen 70 is positioned to block or trap any non-liquid contraband 80 items from flowing downstream along the main sewer line 30 while allowing water to flow unrestricted and without backup. The camera 26, attached to the power tracker 24, is placed 88 in the upstream manhole 74 and sent through the main sewer pipe 30. The camera 26 returns images of the main sewer pipe 30 to the video monitor 14 of the portable monitoring unit 12. The camera crew controls the tracker 24 as it negotiates it way through the pipe 30 in the downstream direction by viewing the video feedback and using the controller 16. These images are documented using the video recorder 22. Using the portable monitoring unit equipment 12, the camera crew can locate 90 and pinpoint the exact location of the lateral 34 leading to the suspect house 76. Once the correct lateral 34 is located 90, the camera is positioned 92 just upstream of the lateral connection 34 to the main sewer line 30. This will enable the camera 26 to record any items which may be flushed down the drains during the raid on the suspect location or building 76. The law enforcement team is then notified that the camera is in position and that the recorder is on 94.

If any contraband 80 shows up at the end of the sewer lateral 34 shortly after the raid, it will be recorded coming from the suspect's lateral sewer line, entering the main sewer line and flowing downstream 96. The tracker 24 is then sent downstream 98 to follow the contraband 80. When the tracker 24 reaches the downstream manhole area, the camera crew is able to verify that the contraband 80 has been caught 102 by the catch screen 70. A camera crew member then enters the manhole 72 and secures the contraband 80 as potential evidence 104.

The next step is to verify that the proper lateral sewer connection 34 was identified 106. The tracker 24 is sent back upstream through the main sewer line 30 and returned to its initial surveillance location 106A upstream of the lateral sewer connection 34 of the suspect location or building 76. At this point the raid is typically over, the suspect location 76 or building area has been secured by the law enforcement officers. The camera crew notifies the law enforcement officers that they are again in position 106B. The law enforcement officers within the secured raid site 76 place liquid dye down one or more of the drains or toilets and flush the dye through the sewer system 106C. The camera 26 thus records 106D the dyed liquid coming from the suspect lateral 34 which confirms that the lateral from which the contraband 80 came from is the same lateral designated for the suspect premises 76. By using this method, the law enforcement officers now have three things resulting from this raid: 1) a video tape of the contraband 80 coming from the suspect residence 76 sewer lateral 34; 2) the contraband 80 has been recovered and can be used as evidence; and 3) a video tape record of dye being flushed from the same suspect location 76 as the contraband 80 thus verifying the contraband came from the suspect residence or building. A raid that previously would have produced absolutely nothing now has some viable evidence against the person/persons at the suspect residence 76.

Sometimes events will require additional steps to obtain potential evidence at a raid site 76. If no contraband 80 is located on the premises during the raid and none shows up at the end of the lateral sewer connection 34, it is still possible that the contraband was sent into the sewer system. It is possible that the contraband 80 was unwrapped and dissolved into the water sent down the drain or that the contraband 80 is stuck somewhere prior to reaching the end of the lateral sewer connection 34. In such cases, members of the camera crew will enter the premises of the residence or building 76 and use 108 the push reel unit 40 and the miniature camera 46 modified with the push squeegee 60 and/or residue collector 50. The camera 46 is used to film the house drains and sewer lateral 34 to locate any contraband 80 that may not have made it all the way to the main sewer line 30. If the contraband 80 is stuck, it will be located, recorded 114 and pushed out 116 into the main sewer line using the push squeegee 60. Prior to pushing 116 the substance into the main line 30, the tracker device 24 and camera 26 is repositioned at its surveillance position just upstream of the lateral 34 in order to film the contraband 80 leaving the lateral sewer line and entering the main sewer line. The catch screen 70 is also put in place at the downstream manhole to catch any dislodged contraband 80 and prevent the contraband from flowing downstream.

If no trapped contraband 80 is located or detected, additional steps are again required. It may be that the substance was dissolved into the drain or flush water. If so, it is likely that there will still be a significant amount of residue in the lines. In such cases, the camera crew will again use the push reel unit 40 having the push cable 42 attached to the miniature camera modified with the residue collector 50. The residue collector 50 is inserted 118 into the drains and positioned in the lateral sewer pipe 34. When the water drains through the pipe 34, such as when flushing 120 the toilet, the residue collector 50 becomes at least partially submerged and is able to absorb any dissolved contraband 80 that may not be easily visible, but yet is still present in the pipes 34 after being flushed. After the residue collector 50 has been reeled through the drain pipes/sewer lateral 34, it would be pulled back, secured and then tested for illegal substances and potentially used as evidence 122.

In an alternate embodiment, the method comprises a step 95 in which the power tracker device 24 is modified to capture the contraband 80 as it leaves the lateral sewer connection 34. This will prevent any argument as to the chain of custody of the contraband stemming from the previous method 100 in which the contraband 80 flows down the main sewer 30 past laterals belonging to additional residences or buildings.

In still another embodiment, it is contemplated that the method include a step 95′ where the tracker, or that a portion of the device such as an extension arm with a camera, could enter the lateral 34 from the main sewer line 30 to record and capture any contraband 80 within the lateral sewer 34.

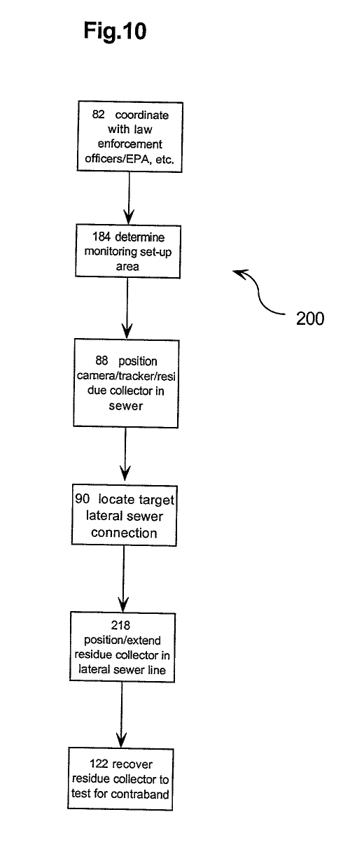

Often, in locations where drugs are being manufactured, by-products, solvents, residue, or other tell-tale substances are flushed down the drains of the building In other situations, businesses may be involved in illegally dumping chemicals or other waste products into their drains in order to cheaply dispose of them. It is contemplated that the present invention can be used to gather evidence of contraband use, contraband manufacturing, illegal dumping of chemicals or other waste products, or any other illegal activity which might show up in the effluent of a building, business, or residence. This evidence can then be used directly in court and/or in order to obtain a search warrant for a raid of the target building, business, or residence. This alternate method 200 of the present invention, as represented in FIG. 10, comprises the following steps typically performed in cooperation with local law enforcement officers 82 or other government agents such as the EPA. Under direction of the law enforcement officers, the sewer camera team determines and selects the proper sewage monitoring set-up area 184. As with the previous embodiment, this location is typically the first upstream manhole 74 from the lateral sewer 34 connection of the building 76 or location which is the subject of effluent monitoring by law enforcement officers or government agency. Again, it is preferable that the crew is positioned further away from the residence or building 76 to avoid causing any suspicion. This is particularly important if the monitoring team is on site for an extended period. In the next step, the residue collector 50 and camera 26, both attached to the power tracker 24, are placed 88 in the upstream manhole 74 and sent through the main sewer pipe 30. The camera 26 returns images of the main sewer pipe 30 to the video monitor 14 of the portable monitoring unit 12. The camera crew controls the tracker 24 as it negotiates it way through the pipe 30 in the downstream direction by viewing the video feedback and using the controller 16. These images are documented using the video recorder 22. Using the portable monitoring unit equipment 12, the camera crew can locate 90 and pinpoint the exact location of the lateral 34 leading to the suspect building 76. Once the correct lateral 34 is located 90, the residue collector 50 is inserted 218 into the lateral sewer line 34. Effluent from the building comes into contact with the residue collector 50 which becomes at least partially submerged and is able to absorb any dissolved contraband 80 or illegal waste product that may be flushed through the sewer pipes 34. After a predetermined period, the residue collector 50 is retracted 220 and the power tracker 24 is returned to the manhole and recovered by the user. The residue collector 50 is secured and then tested for illegal substances and potentially used as evidence 122. It is important the residue collector 50 does not contact effluent from the main sewer line 30 during travel to and from the lateral sewer line 34. It is contemplated that the residue collector 50 can be extended into the lateral 34 from the tracker or that the residue collector is mounted on the tracker 24 which is able to enter the lateral 34.

The duration or monitoring time depends on the type of suspected illegal activity. The suspected lateral 34 can be checked multiple times at predetermined intervals or checked at one time. Residue from illegal substances should still be present in a detectable level for extended periods after they are drained through the sewer system such that more than one check is unnecessary. However, for illegal compounds or chemicals which are harder to detect or which decompose quickly, multiple checks may be necessary. It is also contemplated that modifications can be made to secure the residue collector in the lateral for an extended period when needed.

Although not shown, it is contemplated that other modifications can be made without departing from the scope of the invention. Although the present invention has been described above in detail, the same is by way of illustration and example only and is not to be taken as a limitation on the present invention.

What is claimed is:

1. A method of recovering contraband from a sewer system comprising the steps of:
a) positioning a remotely controlled device having a camera mounted on said device into a first sewer line;
b) locating a sewer connection wherein a second sewer line connects to said first sewer line, said second sewer line servicing a predetermined building;
c) gathering evidence of said contraband originating from said second sewer line; and
d) recovering said contraband.

2. The method of claim 1 in which said step of gathering evidence comprises the step of using said camera and recording said contraband entering said first sewer line from said second sewer line.

3. The method of claim 1 in which prior to step b, further comprising the step of positioning a catch screen in a location downstream of said sewer connection to catch said contraband.

4. The method of claim 3 in which said step of recovering said contraband comprises the steps of:
a) following said contraband with said remotely controlled device and camera downstream within said first sewer line;
b) verifying said contraband is caught by said catch screen; and
c) retrieving said contraband from said sewer system.

5. The method of claim 1 in which said step of recovering said contraband comprises the steps of:
a) capturing said contraband with said remotely controlled device as said contraband enters said first sewer line from said second sewer line; and
b) retrieving said remotely controlled device and said contraband.

6. The method of claim 1 in which said step of gathering evidence comprises the steps of:
a) positioning at least a portion of said remotely controlled device within said second sewer line; and
b) recording said contraband flowing within said second sewer line.

7. The method of claim 6 in which said step of recovering said contraband comprises the steps of:
a) capturing said contraband with said remotely controlled device while said contraband is in said second sewer line; and
b) retrieving said remotely controlled device and said contraband.

8. The method of claim 1 in further comprising the step of:
a) verifying that said second sewer line is associated with said predetermined building.

9. The method of claim 8 in which said step of verifying that said second sewer line is associated with said predetermined building comprises the steps of:
a) entering said predetermined building;
b) flushing a die through a drain within said predetermined building; and
c) using said camera and recording said die entering said first sewer line from said second sewer line.

10. The method of claim 1 in which said step of gathering evidence comprises the steps of:
a) entering said predetermined building;
b) placing a cable having a means for pushing/dislodging any stuck contraband through a drain of said predetermined building;
c) pushing said cable through said drain to and through said second sewer system; and
d) recording with said camera said contraband being pushed through said second sewer line.

11. The method of claim 1 in further comprising the initial step of:
a) coordinating activities with appropriate government agents.

12. A method of recovering contraband from a sewer system comprising the steps of.
a) positioning a remotely controlled camera and a residue collector in a first sewer line;
b) locating a sewer connection wherein a second sewer line connects to said first sewer line wherein said second sewer line services a predetermined building;
c) positioning said residue collector within said second sewer line such that at least a portion of any contraband dissolved within an effluent flowing through said second sewer line is captured by said residue collector;
d) retrieving said residue collector from said second sewer line;
e) testing said residue collector for said contraband.

13. A system for recovering contraband from a sewer system comprising:
a remotely controlled device movable within said drainage/sewer system;
a camera mounted on said device; and
means for capturing said contraband.

14. The system of claim 13 in which said means for capturing said contraband is comprised of a screen positioned in said sewer system to prevent said contraband from flowing away through said sewer system.

15. The system of claim 13 in which said means for capturing said contraband is comprised of a residue collector which captures particles in an effluent flowing through a portion of said sewer system.

16. The system of claim 15 in which said residue collector comprises at least in part an absorbent material.

17. The system of claim 13 in which said remotely controlled device is a push cable wherein said camera is generally mounted on a leading end of said push cable.

18. The system of claim 13 in which said means for capturing said contraband is comprised of a push squeegee designed to push/dislodge stuck contraband through a drain system of a building associated with said sewer system.

19. A system for recovering contraband from a building drain and associated sewer system comprising:
a remotely controlled device movable within said building drain and sewer system;
a camera mounted on said device; and
means for pushing said contraband through said building drain and sewer system to a position where said contraband is recoverable.

20. The system of claim 19 in which said remotely controlled device is a push cable wherein said camera is generally mounted on a leading end of said push cable.
